(19) United States
(12) Patent Application Publication
(10) Pub. No.: US 2020/0198805 A1
(43) Pub. Date: Jun. 25, 2020

(54) ELECTRICAL ADAPTER, DISPLAY SYSTEM FOR AN AIRCRAFT AND AIRCRAFT

(71) Applicant: Airbus Operations GmbH, Hamburg (DE)

(72) Inventors: Gerd BRÜCHMANN, Hamburg (DE); Christian RIEDEL, Hamburg (DE)

(21) Appl. No.: 16/718,723

(22) Filed: Dec. 18, 2019

(30) Foreign Application Priority Data
Dec. 20, 2018 (DE) 102018133176.2

(51) Int. Cl. B64F 5/10; B64D 11/00; H04L 12/10; G06F 3/147; H04L 29/08

(52) U.S. Cl. CPC B64F 5/10; B64D 11/0015; H04L 67/12; G06F 3/147; H04L 12/10

(57) ABSTRACT

An electrical adapter for connecting a panel to a cabin management system for an aircraft, wherein the electrical adapter is configured to connect the cabin management system and the panel to one another, having at least one processor and a memory and also having at least one interface for the cabin management system and having at least one further interface, wherein the at least one further interface allows a data transfer to the panel and/or the cabin management system. Also, a display system is provided for an aircraft having a cabin management system, a panel for presenting information, wherein the panel comprises hardware and software for monitoring image information presented on the panel, and an electrical adapter for connecting the panel to the cabin management system.

### CROSS-REFERENCES TO RELATED APPLICATIONS

This application claims the benefit of the German patent application No. 102018133176.2 filed on Dec. 20, 2018, the entire disclosures of which are incorporated herein by way of reference.

### FIELD OF THE INVENTION

The present invention relates to an electrical adapter for connecting a panel to a cabin management system for an aircraft, and relates to a display system for an aircraft. It further also relates to an aircraft cabin monument having a display system.

### BACKGROUND OF THE INVENTION

The prior art reveals a cabin management system (e.g., the cabin intercommunication data system, CIDS) for an aircraft, which is connected to at least one panel.

Such a cabin management system necessitates a large amount of wiring to various cabin systems having input and/or output functions.

A disadvantage of such a cabin management system is that the intensive wiring means that the cabin management system is more or less deeply routed within the aircraft. This means that in the event of technical incompatibility it is possible to connect new technical systems to an existing cabin management system only with a very high level of wiring complexity. This is the case in particular for the panels (also called “displays” herein) for reproducing information for the cabin personnel. Such panels are, for example, the flight attendant panel (FAP), on which commands can be input and information can be read, or the area indication panel (AIP), which again only conveys information to the cabin crew, or else various other panels.

### SUMMARY OF THE INVENTION

It is an object of the present invention to allow panels or displays that are to be newly added to the cabin management system installed in an aircraft to be compatible with the cabin management system regardless of the age thereof.

The electrical adapter is suitable for connecting a panel (i.e., a monitor or display) to a cabin management system for an aircraft. In this instance, the electrical adapter is suitable for connecting the cabin management system and the panel to one another by means of Power over Ethernet, for example. This can be effected by means of two-wire technology, for example, that is to say, by means of a conventional ribbon cable. The electrical adapter further has at least one processor and a memory (e.g., a SMARC 2.0 module or a similar commercially available module) and also at least one interface for a communication or data transfer from and/or to the cabin management system. Furthermore, the electrical adapter also has at least one further interface allowing a data transfer to the panel and/or to the cabin management system.

The at least one interface preferably allows a data transfer for the cabin management system from or to at least one element from the following group: aircraft network architecture (e.g., the “airline network architecture” (ALNA)) module or another network connectable via Ethernet, diagnosis module, pin programming module or from an external element via universal serial bus (USB) port.

In this manner, all aircraft-relevant data can first of all be received by the electrical adapter or the processor in the electrical adapter. This allows cabin-management-system-related data or information to be supplied by the cabin management system itself or else separately or externally by means of the USB port, that is to say, not via the cabin management system.

Furthermore, the at least one further interface of the electrical adapter allows a data transfer to the panel and/or the cabin management system from or to at least one element from the following group: near field communication (NFC) module, USB port, sensors, solid state drive (SSD) card, loudspeaker.

These cited communication options allow a wide variety of connectable devices and permit a large bandwidth for different types of information flow.

The electrical adapter professes, as it were, to the cabin management that a modern device connected to the adapter is consistent with an earlier standard.

A further aspect of the present invention relates to a display system for an aircraft having a cabin management system, at least one panel for presenting information, wherein the panel comprises hardware and software for monitoring image information presented on the panel, and an electrical adapter as described previously for connecting the panel to the cabin management system. This reduced configuration of the panel allows it to be made particularly shallow, which in turn has the advantage that the panel together with the adapter requires only a shallow installation depth in an aircraft that is narrow in any case. Additionally, a display of the same design, possibly just in a different size, can thus be used for a very large number of panels used in an aircraft.

Preferably, the panel in a display system according to the invention has a diagonal size of 18″, 13″ to 15″ or 3″. These sizes usually cover all popular panel sizes in an aircraft cabin, but larger or smaller embodiments are naturally also conceivable for such a panel.

Preferably, the display system has an electrical adapter suitable for keeping the panel in a vertical or horizontal position. In the simplest case, this can be accomplished by screws or bolts. Alternatively, there may be a swivel mechanism/joint in order to provide for uncomplicated reorientation of the panel.

In the display system according to the invention, the electrical adapter is advantageously connectable to the panel via a J1 connector and/or a J6 connector, that is to say, conventional and inexpensive connector types. To waste as little space as possible, a two-wire or ribbon cable connection is possible in this case too.

Preferably, the panel in the display system has a thickness d of 5 to 10 mm, but particularly preferably of 1 to 5 mm, and the electrical adapter together with the panel has at most a thickness D of 25 to 30 mm, or particularly preferably 5 to 10 mm.

Especially preferably, the panel in the display system described above is an overhead display, an info panel, an in-flight entertainment (IFE) panel, an ALNA control panel, a digital galley panel, a eDirect view panel, an additional attendant panel (AAP), an attendant indication panel (AIP) or a flight attendant panel (FAP). These are all known to be popular displays in an aircraft cabin. Other panels requiring a connection to the cabin management system are also fundamentally conceivable, however.

Fundamentally, parts of the display system according to the invention may be contained in a conventional aircraft cabin monument (a partition wall, galley wall or lavatory wall). In this instance, the aircraft cabin monument can have a three-dimensional cutout for the electrical adapter, for example, so that the electrical adapter together with the panel protrudes from the cutout by less than 5 to 10 mm. Another configuration option is for the adapter/panel complex to directly form part of a wall. A common feature of all of these arrangements is that the electrical adapter is at least partly surrounded by an aircraft cabin monument. The display system according to the invention is ultimately in an aircraft in an installed state.

### BRIEF DESCRIPTION OF THE DRAWINGS

The invention will now be explained with reference to the drawings that follow.

FIG. 1, split into the two views of FIG. 1A and FIG. 1B due to size constraints, shows a block diagram of an electrical display system according to the invention, in particular having the electrical adapter according to the invention, which is connected to a panel.

FIGS. 2a and 2b schematically show how the electrical adapter according to the invention together with a panel is secured to or in a cabin monument.

FIG. 3 shows an exploded depiction of an electrical adapter according to the invention together with panels of different size.

FIG. 4 shows an aircraft in which a display system according to the invention or an electrical adapter according to the invention can be installed.

### DETAILED DESCRIPTION OF THE PREFERRED EMBODIMENTS

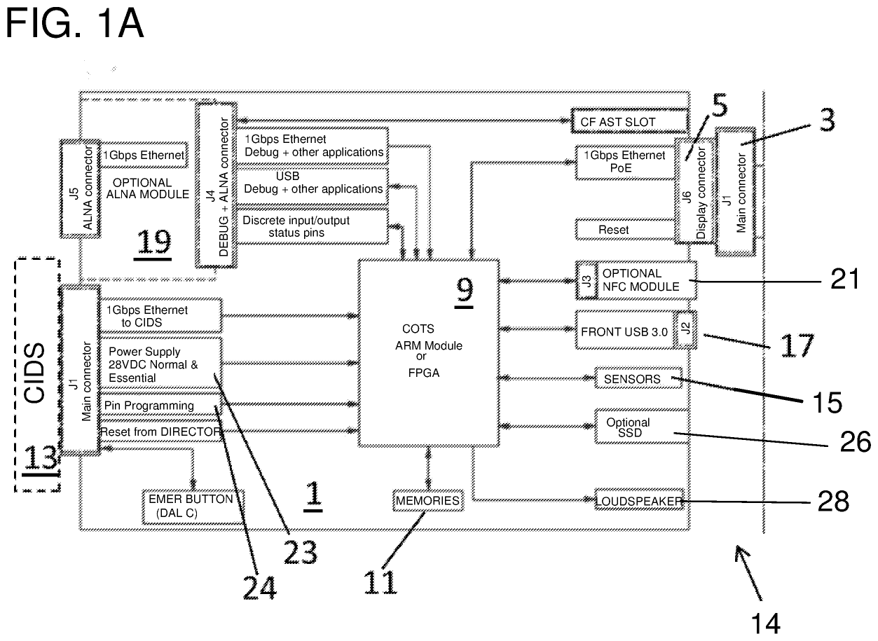

The FIG. 1A portion of FIG. 1 shows an electrical adapter 1 according to the invention, which is connected (Power over Ethernet (POE) connection) to a panel 7 (FIG. 1B) via a J1 connector 3 (main connection) and a J6 connector 5 (panel connection). The electrical adapter 1 has a commercially available processor 9 that is connected to a memory 11. The electrical adapter 1 is logically situated between the cabin management system 13 and the panel 7. On the one hand, the adapter 1 hands over output functions directly to a terminal. In FIG. 1A, this is a loudspeaker 13, for example. Alternatively, the adapter 1 receives input functions or information directly from another terminal. In FIG. 1A, this would be, e.g., the schematically depicted sensors 15, that is to say, for example, air-conditioning sensors (temperature, humidity), status sensors (e.g., for galley latches, cargo latches or cabin layout sensors) or other types of sensors. The depicted electrical adapter 1 can also pass on information to the cabin management system 13 or the panel 7 via a USB port 17, however. The depicted electrical adapter 1 comprises a communication module, e.g., the “airline network architecture” (ALNA) module 19 (or another network connected via Ethernet), for the purpose of transferring information from the cabin management system 13 to other cabin systems, in particular to the panel 7 shown. Fundamentally, this ALNA module 19 is optional, as is the indicated near field communication (NFC) module 21. The electrical adapter 1 is connected or connectable to the cabin management system 13, to the (optional) ALNA module 19, or else to the panel 7 via a 10 Gbps Ethernet connection. The fundamental power supply 23 for the whole adapter 1 is also provided via a 28 VDC provision via the cabin management system 13 (known as normal or essential power).

In principle, the depicted electrical adapter 1 for connecting a panel 7 to a cabin management system 13 for an aircraft is thus suitable for connecting the cabin management system 13 and the panel 7 to one another by means of Power over Ethernet. The adapter 1 has at least one processor 9 and a memory 11 and also at least one interface for the cabin management system 13. It further has at least one further interface allowing a data transfer to the panel 7 and/or the cabin management system 13.

The at least one interface for the cabin management system 13 allows a data transfer from or to an aircraft network architecture (e.g., ALNA) module 19 (or another network connected via Ethernet) or a USB port 17, but, in particular, also from or to a diagnosis module (not visible) and a pin programming module 24.

The at least one further interface of the electrical adapter 1 in turn allows a data transfer to the panel 7 and/or the cabin management system 13 from or to an NFC module 21, a USB port 17, sensors 15, an SSD card 26 or a loudspeaker 28.

Together with the panel 7 depicted in FIG. 1B and the schematically indicated cabin management system 13, the display system 14 according to the invention for an aircraft is obtained. The panel 7 is supposed to present information, in particular, and comprises hardware and software for monitoring image information presented on the panel 7.

The depicted panel 7 can have a diagonal size of 18″, 13″ to 15″ or 3″, but other display sizes are naturally also conceivable. In the display system 14 according to the invention, the panel 7 has a thickness d of 5 to 10 mm, preferably 1 to 5 mm Together (that is to say, in the plugged-together state) the electrical adapter 1 and the panel 7 have a maximum thickness D of 25 to 30 mm, preferably of 5 to 10 mm. The schematically depicted panel 7 can be, in particular, an overhead display, an info panel, an in-flight entertainment (IFE) panel, an ALNA control panel, a digital galley panel, an eDirect view panel, an additional attendant panel (AAP), an attendant indication panel (AIP) or a flight attendant panel (FAP). Fundamentally, however, all possible types of panels and displays are conceivable for different purposes. In particular, the panel 7 as depicted comprises a commercially available controller 25 controlling the presentation of the image information as image content (“display controller”). Furthermore, the panel 7 has a controller 27 for a touch-sensitive input function (a touchscreen) (“touch controller”). The panel 7 shown can supply or receive information to or from a WLAN 29 of an aircraft. In particular, the panel 7 can allow a data connection to a camera 31 and can also comprise a memory 33 of its own. The camera 31 is preferably a space-saving small “microcamera.”

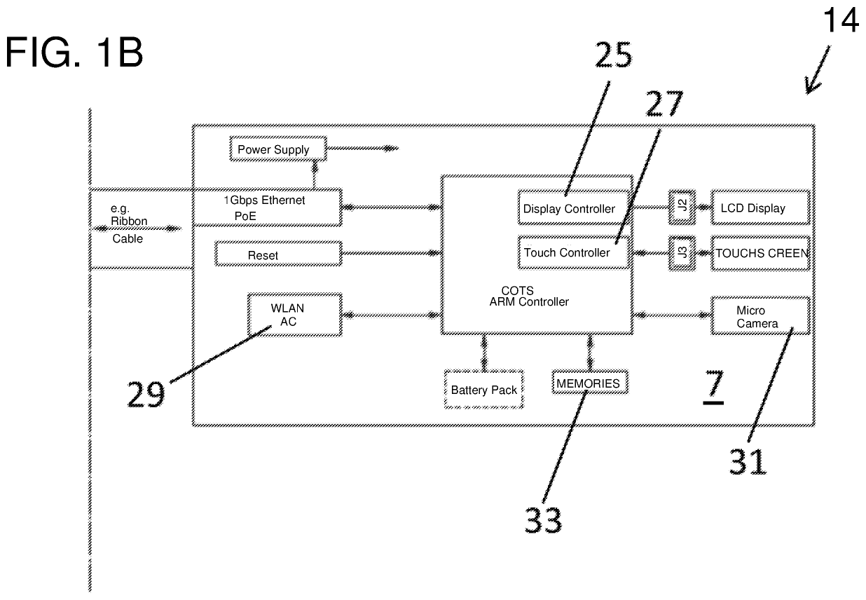

FIG. 2a shows the wall of an aircraft cabin monument 32 having the electrical adapter 1 according to the invention as described above in the state connected to a panel 7. FIG. 2b shows a section through the wall of the aircraft cabin monument 32: the electrical adapter is recessed in the wall of the aircraft cabin monument, which partly surrounds it. As can be seen, the adapter 1 has a small three-dimensional cutout 35 on its side facing the panel 7, which serves as a cable duct 35. Preferably, the panel 7 and the adapter 1 are connectable via a space-saving ribbon cable, which can used to make a Power over Ethernet connection. The cabin monument, that is to say, for example, a galley, a washroom or toilet (lavatory) or a partition wall, or a cabin wall can each have a three-dimensionally recessed area for holding the electrical adapter 1—naturally also together with the panel 7. This allows space-saving installation of this part of the display system 14 according to the invention, and therefore also a modernized cabin layout. This is important in particular for the “retrofit,” which involves an aircraft undergoing restructuring, e.g., in the cabin.

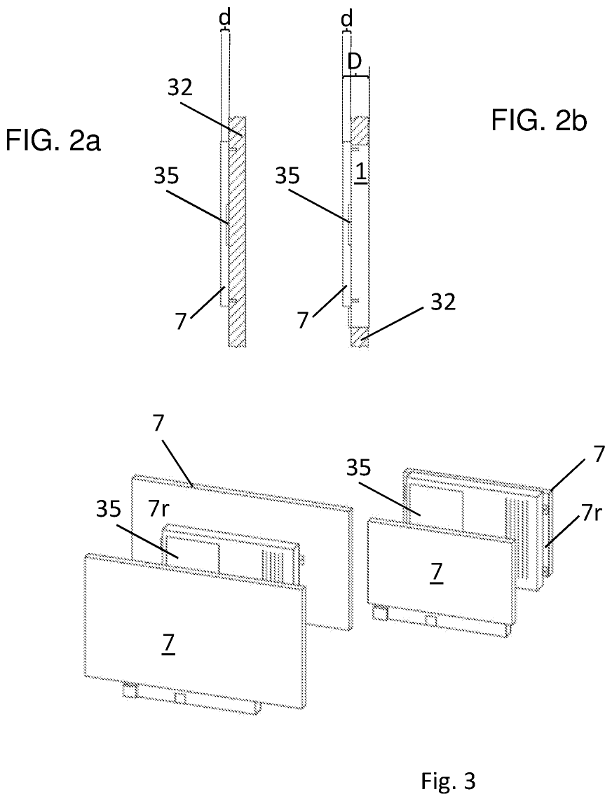

This cable duct 35 can also be seen once again in FIG. 3: the depiction is of a larger panel 7 and a smaller panel 7, each one from the front, and directly behind each of them it is possible to see the associated rear view (panel or display rear wall has the reference sign 7r). In the present case, it can be seen that the adapter 1 (which is constant in terms of size) is connected to each panel 7, once to a larger display (e.g., 18″) and once to a smaller display (e.g., 13″ to 15″).

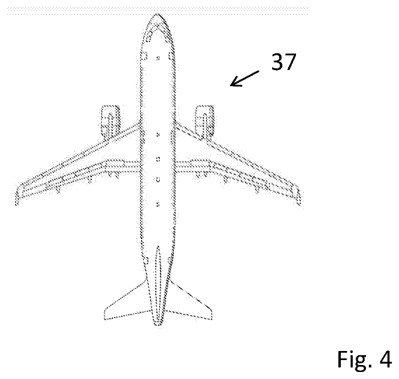

Finally, FIG. 4 portrays an aircraft 37 in which the electrical adapter 1 according to the invention or the display system 14 according to the invention can be accommodated.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

1 Electrical adapter
3 J1 connector
5 J6 connector
7 Panel
7r Rear wall of the panel
9 Processor
11 Memory
13 Cabin management system
14 Display system
15 Sensors
17 USB port
19 Aircraft network architecture (ALNA) module
21 Near Field Communication (NFC) module
23 Power supply
24 Pin programming module
25 Controller
26 SSD card
27 Touch controller
28 Loudspeaker
29 WLAN
31 Camera
32 Aircraft cabin monument
33 Memory
35 Three-dimensional cutout/cable duct
37 Aircraft
d Thickness of the panel
D (Joint) thickness of the electrical adapter and the panel

1. An electrical adapter for connecting a panel to a cabin management system for an aircraft, wherein the electrical adapter is configured to connect the cabin management system and the panel to one another, and comprises:
at least one processor and a memory,
at least one interface for the cabin management system, and
at least one further interface,
wherein the at least one further interface is configured to allow a data transfer to at least one of the panel or the cabin management system.

2. The electrical adapter as claimed in claim 1, wherein the electrical adapter is configured to connect the cabin management system and the panel to one another by means of at least one of two-wire line or Power over Ethernet.

3. The electrical adapter as claimed in claim 1, wherein the at least one interface for the cabin management system is configured to allow a data transfer from or to at least one element from the group consisting of: an aircraft network architecture (ALNA) module, a USB port, a diagnosis module, and a pin programming module.

4. The electrical adapter as claimed in claim 1, wherein the at least one further interface is configured to allow a data transfer to at least one of the panel or the cabin management system from or to at least one element from the group consisting of: an NFC module, a USB port, sensors, an SSD card, a loudspeaker.

5. A display system for an aircraft having
a cabin management system,
a panel for presenting information, wherein the panel comprises hardware and software for monitoring image information presented on the panel, and
an electrical adapter as claimed in claim 1 for connecting the panel to the cabin management system.

6. The display system as claimed in claim 5, wherein the panel has a diagonal size in a range of 3″ to 18.″

7. The display system as claimed claim 5, wherein the electrical adapter is configured to keep the panel in a vertical or horizontal position.

8. The display system as claimed in claim 5, wherein the electrical adapter is configured to connect to the panel via at least one of a J1 connector or a J6 connector.

9. The display system as claimed in claim 5, wherein the panel has a thickness in a range of 1 to 5 mm, and wherein the electrical adapter together with the panel has a thickness of not greater than 10 mm.

10. The display system as claimed in claim 5, wherein the panel comprises one from the group consisting of: an overhead display, an info panel, an in-flight-entertainment panel, an ALNA control panel, a digital galley panel, an eDirect view panel, an additional attendant panel, an attendant indication panel, and a flight attendant panel.

11. An aircraft having a display system as claimed in claim 5.

12. An aircraft cabin monument having a display system as claimed in claim 5.

13. The aircraft cabin monument as claimed in claim 12, wherein the display system is at least partly surrounded by the aircraft cabin monument.
